(19) United States
(12) Patent Application Publication
(10) Pub. No.: US 2008/0170885 A1
(43) Pub. Date: Jul. 17, 2008

(54) DEVELOPING DEVICE AND IMAGE FORMING APPARATUS

(75) Inventors: Takashi Hatakeyama, Kanagawa-ken (JP); Minoru Yoshida, Tokyo (JP); Takao Izumi, Kanagawa-ken (JP); Hiroshi Murata, Kanagawa-ken (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/966,322

(22) Filed: Dec. 28, 2007

Related U.S. Application Data
(60) Provisional application No. 60/885,285, filed on Jan. 17, 2007.

(30) Foreign Application Priority Data
Apr. 18, 2007 (JP) 2007-108982

(51) Int. Cl. G03G 15/08

(52) U.S. Cl. 399/254

(57) ABSTRACT

A developing device that enables stable discharge of a developer from a developer discharge port, and an image forming apparatus having this developing device are provided.

A developing device in which a developer is supplied to a developing roller and the developer is carried while it is stirred, includes: a developer passage through which the developer can be carried; a carrying member which is provided in the developer passage and has a rotary shaft and a rotary wing spirally provided along an outer circumference of the rotary shaft, in which the rotary wing rotates about the rotary shaft, thereby carrying the developer into a carrying direction along the rotary shaft, and which has a first section where the rotary wing has a constant characteristic in the carrying direction and a second section where the characteristic of the rotary wing gradually changes with respect to position in the carrying direction; and a discharge port provided at a position in the carrying direction that is in a section overlapping the second section or a section downstream of the second section in the carrying direction, and adapted for discharging the developer having a surface height of a predetermined value or more, from the developer passage.

### BACKGROUND OF THE INVENTION

1. Field of the Invention

The present invention relates to a developing device that develops an electrostatic latent image formed on a photoconductive member to a toner image in an image forming apparatus such as an electrophotographic copy machine or laser printer, and an image forming apparatus.

2. Description of the Related Art

Traditionally, there is a developing device that develops an electrostatic latent image formed on the surface of an image carrier (photoconductive member) with a two-component developer including toner and carrier. In such a developing device, the toner is consumed in image formation from a developing container housing the two-component developer, whereas the carrier is not consumed and remains within the developing container. This remaining carrier causes stripping of a resin coating material on the carrier surface and adhesion of the toner component to the carrier surface as the image formation is repeated. This phenomenon lowers the charging performance or the like of the developer and generates fog, uneven density or the like due to charging failure of the toner, thus causing degradation of image quality.

In order to restrain such deterioration of the developer, a system in which a developer made of a mixture of carrier and toner is supplied into the developing container, or a system in which carrier and toner are separately supplied into the developing container, has been proposed. Here, though the toner is consumed in image formation, the carrier remains in the developing container. Therefore, the developer in the developing container increases if the toner concentration of the developer is to be kept constant. Thus, to reduce the excess developer in the developing container, the developer may be caused to overflow and thus be discharged from a developer discharge port provided in a developing container wall surface. This system is called a trickle system. Since the developer deteriorating in the developing container is replaced by newly supplied toner and carrier, the charging performance of the developer is maintained and degradation of image quality can be restrained.

In the above-described system where supply and discharge of the developer are repeated, it is desired that the quantity of developer in the developing container is maintained within a proper range. If the quantity of developer is too large, it cannot be stirred sufficiently and therefore it generates unevenness, fog or the like. Conversely, if the quantity of developer is too small, the supply of the developer to the developing roller is insufficient and image quality defects such as uneven density and white spots may occur.

To cope with this problem, a developing device shown in FIGS. 14 to 16 is proposed. FIG. 14 is a schematic sectional view showing a first example of a traditional developer carrying path. FIG. 15 is a schematic sectional view showing a second example of a traditional developer carrying path. FIG. 16 is a schematic sectional view showing a third example of a traditional developer carrying path. Here, a developing roller 82 and a developer discharge port 88 are indicated by dotted lines for reference.

This developing device 80 has a developer carrying member 84 arranged in a developer carrying path 86, and the developer discharge port 88. The developer carrying member 84 includes a rotary shaft 84a and a rotary wing 84b. Moreover, as a carrying part 90 is provided in the developer carrying member 84 in a section on the developer carrying path 86 where the developer discharge port 88 is arranged, the quantity of the developer to be carried is reduced and a developer surface 92 is locally raised so that the developer will be discharged from the developer discharge port 88. Thus, the quantity of developer in the developing container is adjusted. Here, in the carrying part 90, the outer diameter and pitch size of the rotary wing 84b are adjusted to reduce the quantity of carried developer. Some forms of this carrying part 90 are proposed, for example, a carrying part in which the outer diameter of the rotary wing 84b is reduced a predetermined manner as shown in FIG. 14, a carrying part in which the pitch of the rotary wing 84b is narrowed in a predetermined manner as shown in FIG. 15, and a carrying part in which the outer diameter of the rotary wing 84b is reduced in a predetermined manner and the pitch of the rotary wing 84b is narrowed in a predetermined manner as shown in FIG. 16 (see, for example, JP-A-2000-81787).

However, in the above traditional developing device, the shape of the developer carrying member 84 in the carrying part 90 near the developer discharge port 88 sharply changes. This causes an upstream part of the rising part of the developer surface 92 to fluctuate vertically as indicated by an arrow 93, and the rising part becomes unstable, preventing proper discharge of the developer. As a result, the quantity of the developer in the developing container greatly changes and this causes uneven density, white spots and the like. Thus, high image quality cannot be maintained.

### SUMMARY OF THE INVENTION

It is an object of an embodiment the invention to provide a developing device which enables stable discharge of a developer from a developer discharge port, and an image forming apparatus having this developing device.

To address the above problems, according to an aspect of the invention, a developing device in which a developer is supplied to a developing roller and the developer is carried while it is stirred, includes: a developer passage through which the developer can be carried; a carrying member which is provided in the developer passage and has a rotary shaft and a rotary wing spirally provided along an outer circumference of the rotary shaft, in which the rotary wing rotates about the rotary shaft, thereby carrying the developer into a carrying direction along the rotary shaft, and which has a first section where the rotary wing has a constant characteristic in the carrying direction and a second section where the characteristic of the rotary wing gradually changes with respect to position in the carrying direction; and a discharge port provided at a position in the carrying direction that is in a section overlapping the second section or a section downstream of the second section in the carrying direction, and adapted for discharging the developer having a surface height of a predetermined value or more, from the developer passage.

According to another aspect of the invention, a developing device in which a developer is supplied to a developing roller and the developer is carried while it is stirred, includes: a developer passage through which the developer can be carried; carrying means provided in the developer passage and having a first section where the developer is carried in a predetermined quantity of carried developer into a developer carrying direction and a second section where the quantity of the carried developer is equal to or less than the quantity of carried developer in the first section and the quantity of the carried developer is gradually reduced with respect to position in the carrying direction; and discharge means for discharging the developer having its surface raised in the second section, from the developer passage.

According to still another aspect of the invention, an image forming apparatus in which a developer is carried while it is stirred, includes: a developer passage through which the developer can be carried; a carrying member which is provided in the developer passage and has a rotary shaft and a rotary wing spirally provided along an outer circumference of the rotary shaft, in which the rotary wing rotates about the rotary shaft, thereby carrying the developer into a carrying direction along the rotary shaft, and which has a first section where the rotary wing has a constant characteristic in the carrying direction and a second section where the characteristic of the rotary wing gradually changes with respect to position in the carrying direction; a discharge port provided at a position in the carrying direction that is in a section overlapping the second section or a section downstream of the second section in the carrying direction, and adapted for discharging the developer having a surface height of a predetermined value or more, from the developer passage; and a developing roller which develops an electrostatic latent image by using the developer carried by the carrying member.

### DESCRIPTION OF THE DRAWINGS

FIG. 1 is a schematic configuration view of an image forming apparatus having a developing device according to a first embodiment.

FIG. 2 is a sectional view perpendicular to the axial direction of a developing roller 40 of a developing device 20 according to the first embodiment.

FIG. 3 is a sectional view of the developing device according to the first embodiment, as viewed along the line Y1-Y1 in FIG. 2.

FIG. 4A is a sectional view of the developing device according to the first embodiment, as viewed along the line Y2-Y2 in FIG. 2.

FIG. 4B is a front view of a developer carrying member 56 with a second carrying part 64 described further in detail, of the second developer carrying member 56 shown in FIG. 4A.

FIG. 5 is a sectional view of a developing device according to a second embodiment, as viewed along the line Y2-Y2 in FIG. 2.

FIG. 6 is a sectional view of a developing device according to a third embodiment, as viewed along the line Y2-Y2 in FIG. 2.

FIG. 7 is a sectional view of a developing device according to a fourth embodiment, as viewed along the line Y2-Y2 in FIG. 2.

FIG. 8 is a sectional view of a developing device according to a fifth embodiment, as viewed along the line Y2-Y2 in FIG. 2.

FIG. 9A is a sectional view of a second example of the developing device according to the fifth embodiment, as viewed along the line Y2-Y2 in FIG. 2.

FIG. 9B is a front view of the second carrying part 64 in FIG. 9A.

FIG. 10 is a sectional view of a third example of the developing device according to the fifth embodiment, as viewed along the line Y2-Y2 in FIG. 2.

FIG. 11 is a sectional view of a fourth example of the developing device according to the fifth embodiment, as viewed along the line Y2-Y2 in FIG. 2.

FIG. 12 is a sectional view of a developing device according to a sixth embodiment, as viewed along the line Y2-Y2 in FIG. 2.

FIG. 13 is a sectional view of a developing device according to a seventh embodiment, as viewed along the line Y2-Y2 in FIG. 2.

FIG. 14 is a schematic sectional view showing a first example of a traditional developer carrying path.

FIG. 15 is a schematic sectional view showing a second example of a traditional developer carrying path.

FIG. 16 is a schematic sectional view showing a third example of a traditional developer carrying path.

### DESCRIPTION OF THE EMBODIMENTS

Hereinafter, embodiments of the invention will be described with reference to the drawings.

### First Embodiment

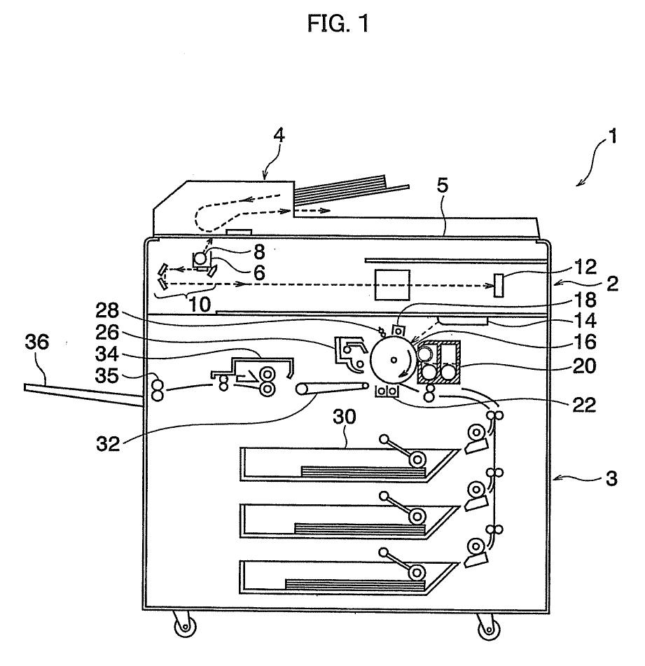

FIG. 1 is a schematic configuration view of an image forming apparatus having a developing device according to a first embodiment of the present invention. As shown in FIG. 1, the image forming apparatus 1 has an image reading unit 2 that reads an image of a reading target, and an image forming unit 3 that forms an image.

The image reading unit 2 has a translucent document setting table 5, a carriage 6, an exposure lamp 8 provided on the carriage 6, a reflecting mirror 10, and a CCD 12 (charged coupled device) that takes in reflected light and converts image information based on the light to an analog signal.

The image forming unit 3 has a photoconductive member 16, a laser unit 14 that forms an electrostatic latent image on the photoconductive member 16, and a charging device 18, a developing device 20, a transfer device 22, a cleaner 26 and a electricity eliminating lamp 28, which are sequentially arranged around the photoconductive member 16.

When light is cast onto an original set on the document setting table 5 or an original sent by an automatic document feeder 4 from below the document setting table 5 by an exposure unit including the carriage 6 and the exposure lamp 8, reflected light from the original is guided by the reflecting mirror 10 and a reflected light image is projected onto the CCD 12. Image information taken in the CCD 12 is outputted as an analog signal and then converted to a digital signal. After image processing is performed, the signal is sent to the laser unit 14.

As image formation is started, the charging device 18 discharges at a predetermined discharge position and supplies electric charges to the outer circumferential surface of the rotating photoconductive member 16. The laser unit 14 casts a laser beam according to information image onto the outer circumferential surface of the photoconductive member 16 charged to have a uniform potential in the axial direction by the charging device 18. As the laser beam is cast and thus an electrostatic latent image corresponding to the image information of the original is formed and held on the outer circumferential surface of the photoconductive member, a developer (for example, toner) is provided to the outer circumferential surface of the photoconductive member by the developing device 20 and the electrostatic latent image is converted to a toner image, that is, developed.

In this developing device 20, a developing roller 40 is rotatably provided. As this developing roller 40 is arranged to face the photoconductive member 16 and rotates, toner is supplied to the photoconductive member 16. When a toner image is formed on the outer circumferential surface of the photoconductive member 16, this toner image is electrostatically transferred by the transfer device 22 onto a paper carried by a paper feeder 30. After that, the paper is carried to a fixing device 34 via a carrier belt 32 and the toner image transferred onto the paper is solidly adhered, that is, fixed onto the paper by the fixing device 34. The paper on which image formation has been completed by fixing the toner image is discharged to a tray 36 by paper discharge rollers 35.

Meanwhile, the toner that has not been transferred and is remaining on the photoconductive member 16 is removed by the cleaner 26 situated downstream of the transfer device 22 in the rotating direction of the photoconductive member 16. The residual electric charges on the outer circumferential surface of the photoconductive member 16 are eliminated by the electricity eliminating lamp 28.

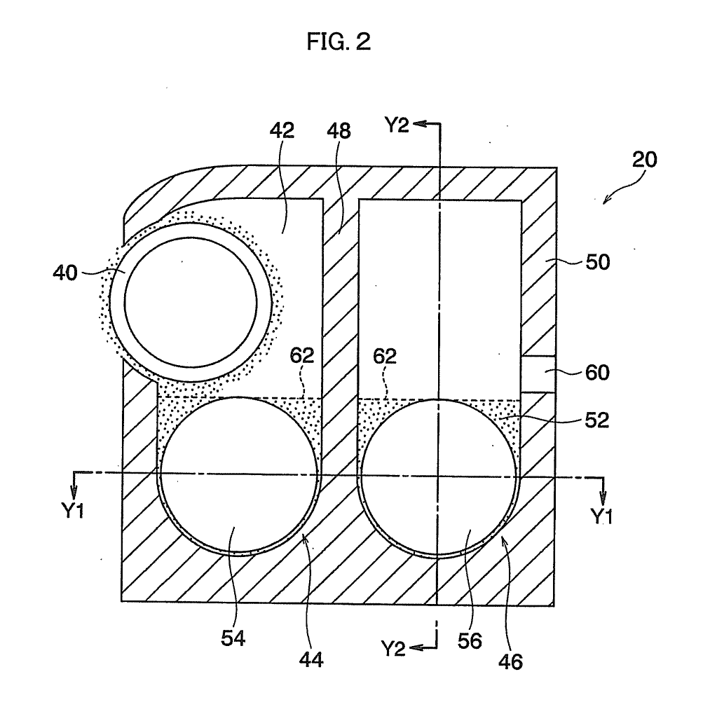

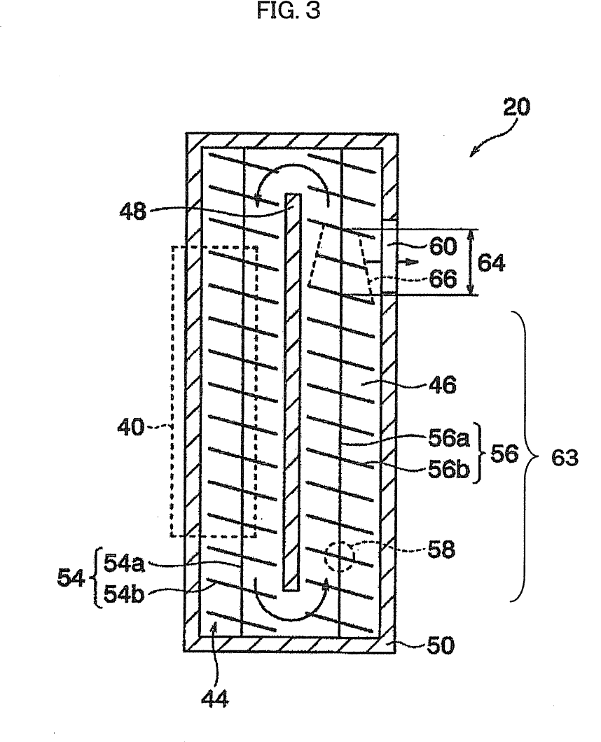

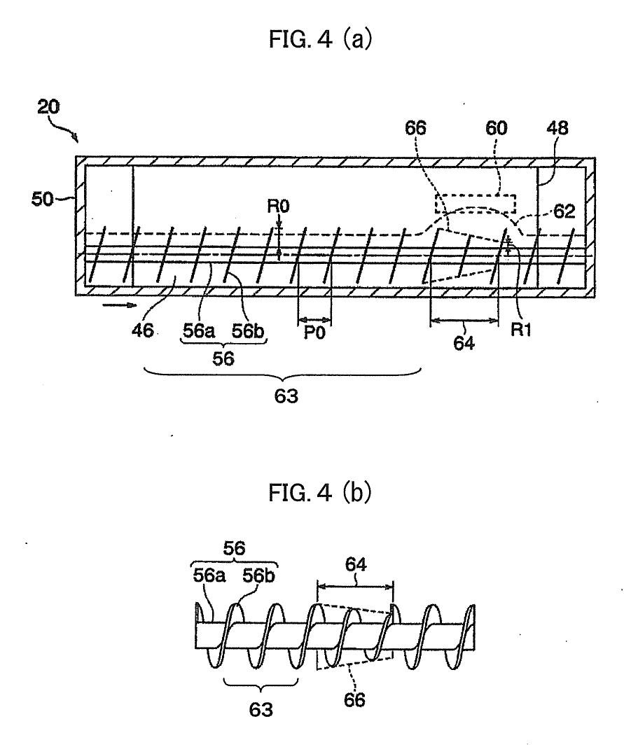

Next, the developing device 20 of the first embodiment according to the invention will be described. FIG. 2 is a sectional view perpendicular to the axial direction of the developing roller 40 of the developing device 20 of the first embodiment according to the invention. FIG. 3 is a sectional view of the developing device according to the first embodiment, as viewed along the line Y1-Y1 of FIG. 2. FIG. 4A is a sectional view of the developing device according to the first embodiment. FIG. 4A is a sectional view of the developing device, as viewed along the line Y2-Y2 in FIG. 2. Since FIG. 4A is a sectional view, the position of a developer discharge port 60 is indicated by a dotted line and the developer roller 40 is not shown. FIG. 4B is a front view of a second developer carrying member 56 with a second carrying part 64 described further in detail, of a second developer carrying member 56 simply described in FIG. 4A.

As shown in FIG. 2 and FIG. 3, the developing device 20 has the developing roller 40, a developing container 50 housing a developer 52, a first developer carrying member 54, and a second developer carrying member 56 (carrying means, carrying member). The developing container 50 has a developing roller housing unit 42, a first developer carrying path 44, and a second developer carrying path 46 (developer passage). The developing roller housing unit 42 houses the developing roller 40. The first developer carrying path 44 is a developer carrying path extending in the axial direction of the developing roller 40 next to the developing roller housing unit 42. The second developer carrying path 46 is a developer carrying path arranged parallel to the first developer carrying path 44. The first developer carrying path 44 and the second developer carrying path 46 continue to each other at both end parts and are partitioned from each other by a partition wall 48 except for both end parts. Also, the second developer carrying path 46 in this example has on its upper side a developer supply port 58 through which a new developer is supplied, and has on its lateral side a developer discharge port 60 (discharge means, discharge port) through which the developer having a predetermined height or more is discharged.

The developer 52 is a two-component developer including, for example, toner and magnetic carrier. The toner includes a binder resin and a coloring agent as principal components. As the binder resin, polystyrene, styrene acrylic copolymer, polyester, epoxy resin, silicone resin, polyamide, paraffin wax or the like can be used. As the coloring agent, an inorganic pigment, an organic pigment, or a combination of these. Specifically, carbon black may be used, and in the case of full-color toner, benzidine yellow, monoazo dye and pigment, or condensed azo dye and pigment may be used as yellow, quinacridone or monoazo dye and pigment may be used as magenta, and phthalocyanine blue or the like may be used as cyan. Also, the toner may contain a charging control agent, cleaning auxiliary agent, mold release agent, fluidity accelerating agent and the like, when necessary.

As the carrier, magnetic particles of ferrite, iron oxide or the like can be used, or a core member made of these and coated with a resin can be used. As the resin that coats the carrier, fluorine, acrylic, silicone resin or the like can be used, and one of these or a combination of plural types can be used. A resin containing magnetic powder can also be used.

The first developer carrying unit 54 and the second developer carrying member 56 are arranged in the first developer carrying path 44 and the second developer carrying path 46, respectively. The first developer carrying member 54 includes a rotary shaft 54a extending in the axial direction of the developing roller 40, and a rotary wing 54b spirally provided along the outer circumference of the rotary shaft 54a. Similarly, the second developer carrying member 56 includes a rotary shaft 56a extending in the axial direction of the developing roller 40, and a rotary wing 56b spirally provided along the outer circumference of the rotary shaft 56a.

As the first developer carrying member 54 and the second developer carrying member 56 rotate, the developer 52 is carried counterclockwise while it is stirred, as indicated by the arrows in FIG. 3. That is, in FIG. 3, the developer 52 is carried from top to bottom in the first developer carrying path 44, then carried from the lower end of the first developer carrying path 44 to the lower end of the second developer carrying path 46 below the partition board 48, then carried from bottom to top in the second developer carrying path 46, and carried from the upper end of the second developer carrying path 46 to the upper end of the first developer carrying path 44 above the partition board 48, thereby circulating in the developing container 50.

A broken line 62 in FIG. 2 and FIG. 4A represents the surface of the developer 52 (hereinafter, developer surface 62). This developer surface 62 refers to the upper surface of the developer 52 housed in the developing container 50. As indicated by dots near the developing roller 40 in FIG. 2, the developer 52 is caused to rise from the developer surface 62 by the magnetic force of a magnetic roller in the developing roller 40 and adheres to the outer circumferential surface of the developing roller 40. Thus, the developer 52 is supplied to the developing roller 40. Therefore, in the section of the first developer carrying path 44 where the developing roller 40 is arranged, the developer surface 62 may not clearly emerge because of the rise of the developer. The developer surface 62 in this section may be considered to be the upper surface of the developer 52 in the case where the developing roller 40 is detached.

Also, the developer 52 is supplied from the developer supply port 58 shown in FIG. 3 and is discharged by overflowing from the developer discharge port 60 provided on the lateral side of the second developer carrying path 46.

Here, of the two developer carrying paths, the configuration of the developer carrying member in the developer carrying path (first developer carrying path 44) where the developer discharge port 60 is not arranged will be described. The first developer carrying member 54 in this embodiment has the rotary shaft 54a with a shaft diameter φ1, and the rotary wing 54b with a pitch P0 and a vane height R0. It carries the developer 52 in a normal quantity of carried developer (first quantity of carried developer). Here, the outer diameter of the rotary wing minus the shaft diameter of the rotary shaft is considered to be the vane height. Also, the shaft diameter φ1, pitch P0 and vane height R0 are constant over the entire first developer carrying member 54.

Next, of the two developer carrying paths, the configuration of the developer carrying member in the developer carrying path (second developer carrying path 46) where the developer discharge port 60 is arranged will be described. The second developer carrying member 56 in this embodiment has the rotary shaft 56a with a shaft diameter φ1, and the rotary wing 56b with a pitch P0 and a vane height R0. It has a first carrying part 63 (first section) where the developer 52 is carried in a first quantity of carried developer, and a second carrying part 64 (second section) provided at a position downstream of the first carrying part 63 in the developer carrying direction and partly overlapping the developer discharge port 60 in the developer carrying direction, where the developer 52 is carried in a quantity of carried developer (second quantity of carried developer) smaller than the first quantity of carried developer in order to locally raise the developer surface 62. In short, the first carrying part 63 is a part excluding the second carrying part 64, of the second developer carrying member 56. With this configuration, the developer 52 is caused to overflow from the developer discharge port 60.

As indicated by a broken line 66 in FIG. 3, FIG. 4A and FIG. 4B, in the second carrying part 64 in this embodiment, the vane height of the rotary wing 56b is gradually reduced from upstream to downstream in the developer carrying direction. With this configuration, the second quantity of carried developer is gradually reduced from the first quantity of carried developer. Here, if the vane height of the rotary wing 56b in the most downstream part of the second carrying part 64 (the minimum value of the vane height of the rotary wing 56b in the second carrying part 64) is R1, for example, R1 is ½ of the vane height R0 of the rotary wing 56b in the first carrying part 63. Also, the pitch of the rotary wing 56b in the second carrying part 64 is constant and is equal to the pitch P0 of the rotary wing 56b in the first carrying part 63. The pitch in this embodiment is the spacing between tops per turn of the rotary wing.

According to this embodiment, since the second carrying part 64 is provided in which the vane height of the rotary wing 56b is gradually reduced from upstream to downstream in the developer carrying direction, the quantity of carried developer is gradually decreased from upstream to downstream in the developer carrying direction in the second carrying part 64. Therefore, the developer surface 62 is not sharply raised. Thus, according to this embodiment, the fluctuation of the developer surface 62 in the upstream of the rise of the developer surface 62 is reduced and the developer surface 62 is stabilized. Therefore, the developer 52 is stably discharged from the developer discharge port 60 and the quantity of the developer 52 in the developing container 50 is maintained properly.

In the second carrying part 64 in this embodiment, the shaft diameter of the rotary shaft 56a is constant with respect to the developer carrying direction and the vane height of the rotary wing 56b is gradually reduced, as indicated by the broken line 66, thus gradually decreasing the second quantity of carried developer. However, the second quantity of carried developer may also be gradually decreased by gradual increase in the shaft diameter of the rotary shaft 56a with respect to the developer carrying direction.

Also, the shape of the second carrying part 64 is not limited to the shape with the vane height of the rotary wing 56b smoothly reduced with respect to the developer carrying direction as shown in FIG. 4B, and it may be a shape with the vane height of the rotary wing 56b reduced in a manner of forming steps (a shape with the vane height of the rotary wing 56b reduced stepwise). That is, at least one step of vane height that is smaller than R0 and larger than R1 may exist between the vane height R0 in the most upstream part and the vane height R1 in the most downstream part of the second carrying part 64.

### Second Embodiment

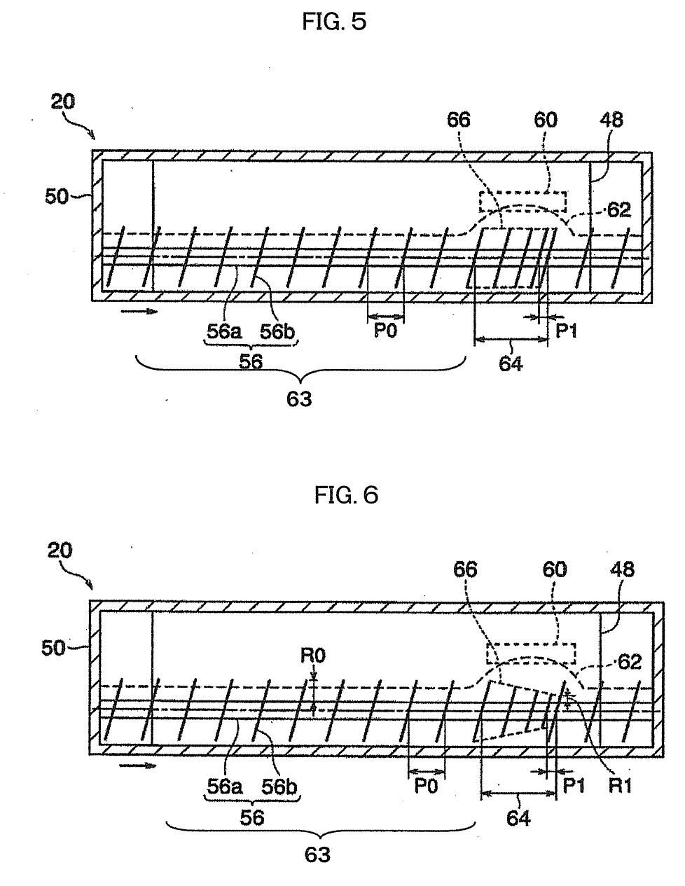

The schematic configurations of the image forming apparatus 1 and the developing device 20 according to this embodiment are similar to FIG. 1 and FIG. 2, respectively. Hereinafter, the same parts as in the first embodiment are denoted by the same reference numerals and only different parts from the first embodiment will be described. FIG. 5 is a sectional view of the developing device according to the second embodiment. Like FIG. 4A, FIG. 5 is a sectional view of the developing device, as viewed along the line Y2-Y2 in FIG. 2.

As shown in FIG. 5, in the second carrying part 64 in this embodiment, the pitch of the rotary wing 56b is gradually decreasing from upstream to downstream in the developer carrying direction, as indicated by the broken line 66. With this configuration, the second quantity of carried developer is gradually reduced from the first quantity of carried developer. Here, if the pitch of the rotary wing 56b in the most downstream part of the second carrying part 64 (minimum value of the pitch of the rotary wing 56b in the second carrying part 64) is P1, for example, P1 is ¼ of the pitch P0 of the rotary wing 56b in the first carrying part 63. As shown in FIG. 5, the vane height of the rotary wing 56b in the second carrying part 64 is constantly R0, which is equal to the vane height of the rotary wing 56b in the first carrying part 63.

According to this embodiment, since the second carrying part 64 is provided in which the pitch of the rotary wing 56b is gradually reduced from upstream to downstream in the developer carrying direction, the quantity of carried developer gradually decreases from upstream to downstream in the developer carrying direction in the second carrying part 64. Therefore, the advantages similar to those of the first embodiment can be achieved.

### Third Embodiment

The schematic configurations of the image forming apparatus 1 and the developing device 20 according to this embodiment are similar to FIG. 1 and FIG. 2, respectively. Hereinafter, the same parts as in the first embodiment are denoted by the same reference numerals and only different parts from the first embodiment will be described. FIG. 6 is a sectional view of the developing device according to the third embodiment. Like FIG. 4A, FIG. 6 is a sectional view of the developing device, as viewed along the line Y2-Y2 in FIG. 2.

As shown in FIG. 6, in the second carrying part 64 in this embodiment, the vane height and pitch of the rotary wing 56b are gradually decreasing from upstream to downstream in the developer carrying direction. With this configuration, the second quantity of carried developer is gradually reduced from the first quantity of carried developer. Here, if the vane height of the rotary wing 56b in the most downstream part of the second carrying part 64 (minimum value of the vane height of the rotary wing 56b in the second carrying part 64) is R1 and the pitch of the rotary wing 56b in the most downstream part of the second carrying part 64 (minimum value of the pitch of the rotary wing 56b in the second carrying part 64) is P1, for example, R1 is ½ of the vane height R0 of the rotary wing 56b in the first carrying part 63 and P1 is ¼ of the pitch P0 of the rotary wing 56b in the first carrying part 63.

According to this embodiment, since the second carrying part 64 is provided in which the vane height and pitch of the rotary wing 56b are gradually reduced from upstream to downstream in the developer carrying direction, the quantity of carried developer gradually decreases from upstream to downstream in the developer carrying direction in the second carrying part 64. Therefore, the advantages similar to those of the first embodiment can be achieved.

### Fourth Embodiment

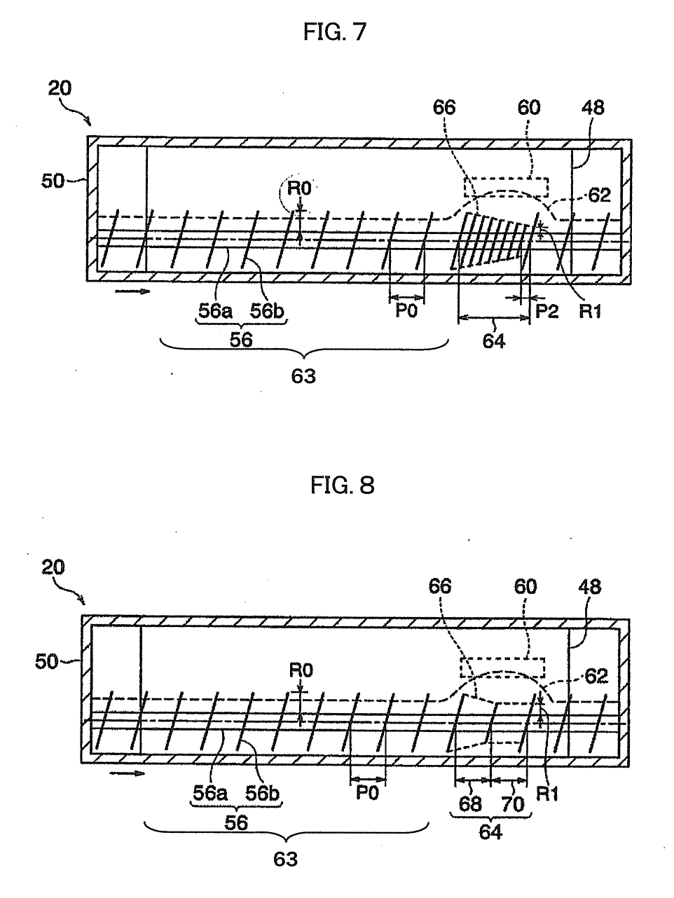

The schematic configurations of the image forming apparatus 1 and the developing device 20 according to this embodiment are similar to FIG. 1 and FIG. 2, respectively. Hereinafter, the same parts as in the first embodiment are denoted by the same reference numerals and only different parts from the first embodiment will be described. FIG. 7 is a sectional view of the developing device according to the fourth embodiment. Like FIG. 4A, FIG. 7 is a sectional view of the developing device, as viewed along the line Y2-Y2 in FIG. 2.

As shown in FIG. 7, in the second carrying part 64 in this embodiment, the vane height of the rotary wing 56b is gradually decreasing from upstream to downstream in the developer carrying direction. With this configuration, the second quantity of carried developer is gradually reduced from the first quantity of carried developer. Here, if the vane height of the rotary wing 56b in the most downstream part of the second carrying part 64 (minimum value of the vane height of the rotary wing 56b in the second carrying part 64) is R1, for example, R1 is ½ of the vane height R0 of the rotary wing 56b in the first carrying part 63. As shown in FIG. 7, the pitch of the rotary wing 56b in the second carrying part 64 is constant. If this pitch is expressed as P2, for example, P2 is ¼ of the pitch P0 of the rotary wing 56b in the first carrying part 63.

According to this embodiment, since the second carrying part 64 is provided in which the pitch is made smaller than in the first carrying part 63 and the vane height of the rotary wing 56b is gradually reduced from upstream to downstream in the developer carrying direction, the quantity of carried developer gradually decreases from upstream to downstream in the developer carrying direction in the second carrying part 64. Therefore, the advantages similar to those of the first embodiment can be achieved.

### Fifth Embodiment

The schematic configurations of the image forming apparatus 1 and the developing device 20 according to this embodiment are similar to FIG. 1 and FIG. 2, respectively. Hereinafter, the same parts as in the first embodiment are denoted by the same reference numerals and only different parts from the first embodiment will be described.

First, a first example of the developing device according to this embodiment will be described. FIG. 8 is a sectional view of the first example of the developing device according to the fifth embodiment. Like FIG. 4A, FIG. 8 is a sectional view of the developing device, as viewed along the line Y2-Y2 in FIG. 2.

The second carrying part 64 in this embodiment has a third carrying part 68 (second section) where the quantity of carried developer is gradually shifted to a smaller quantity, and a fourth carrying part 70 (third section) which is formed to continue from the downstream side of the third carrying part 68 and which holds a constant quantity of carried developer.

As shown in FIG. 8, in the third carrying part 68 in this example, the vane height of the rotary wing 56b is gradually decreasing from upstream to downstream in the developer carrying direction. In the fourth carrying part 70, the vane height of the rotary wing 56b is constant and equal to the vane height in the most downstream part of the third carrying part 68. Meanwhile, the pitch of the rotary wing 56b is constant in the third carrying part 68 and the fourth carrying part 70. With this configuration, the second quantity of carried developer is gradually reduced from the first quantity of carried developer in the third carrying part 68 and becomes constant in the fourth carrying part 70.

Here, the vane height of the rotary wing 56b in the most upstream part of the third carrying part 68 is R0, which is equal to the vane height of the rotary wing 56b in the first carrying part 63. If the vane height of the rotary wing 56b in the most downstream part of the third carrying part 68 (minimum value of the vane height of the rotary wing 56b in the third carrying part 68) is R1, for example, R1 is ½ of the vane height R0 of the rotary wing 56b in the first carrying part 63. The vane height of the rotary wing 56b in the fourth carrying part 70 is constantly R1, which is equal to the vane height of the rotary wing 56b in the most downstream part of the third carrying part 68. The pitch of the rotary wing 56b in the third carrying part 68 and the fourth carrying part 70 is P0, which is equal to the pitch of the rotary wing 56b in the first carrying part 63.

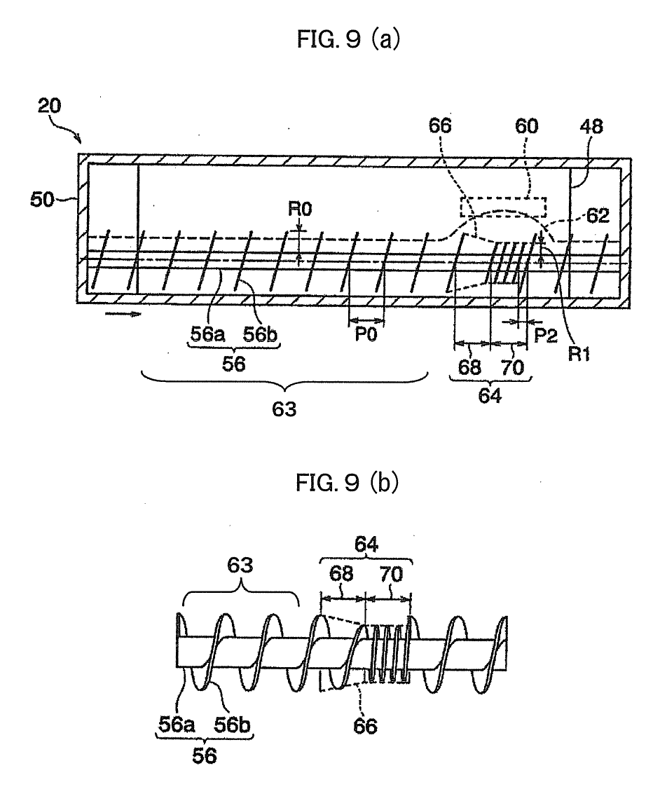

Next, a second example of the developing device according to this embodiment will be described. FIG. 9A is a sectional view of the second example of the developing device according to the fifth embodiment. Like FIG. 4A, FIG. 9A is a sectional view of the developing device, as viewed along the line Y2-Y2 in FIG. 2. FIG. 9B is a front view of the second carrying part 64 in FIG. 9A.

As shown in FIG. 9A and FIG. 9B, in the third carrying part 68 in this example, the vane height of the rotary wing 56b is gradually decreasing from upstream to downstream in the developer carrying direction. In the fourth carrying part 70, the vane height of the rotary wing 56b is constant and equal to the vane height in the most downstream part of the third carrying part 68. Meanwhile, the pitch of the rotary wing 56b in the third carrying part 68 is constant. The pitch of the rotary wing 56b in the fourth carrying part 70 is smaller than in the first carrying part 68 but it is constant. With this configuration, the second quantity of carried developer is gradually reduced from the first quantity of carried developer and becomes constant in the fourth carrying part 70.

Here, the vane height of the rotary wing 56b in the most upstream part of the third carrying part 68 is R0, which is equal to the vane height of the rotary wing 56b in the first carrying part 63. If the vane height of the rotary wing 56b in the most downstream part of the third carrying part 68 (minimum value of the vane height of the rotary wing 56b in the third carrying part 68) is R1, for example, R1 is ½ of the vane height R0 of the rotary wing 56b in the first carrying part 63. The vane height of the rotary wing 56b in the fourth carrying part 70 is constantly R1, which is equal to the vane height of the rotary wing 56b in the most downstream part of the third carrying part 68. The pitch of the rotary wing 56b in the third carrying part 68 is constantly P0, which is equal to the pitch of the rotary wing 56b in the first carrying part 63. The pitch of the rotary wing 56b in the fourth carrying part 70 is constant, and if this pitch is expressed as P2, for example P2 is ¼ of the pitch P0 of the rotary wing 56b in the first carrying part 63.

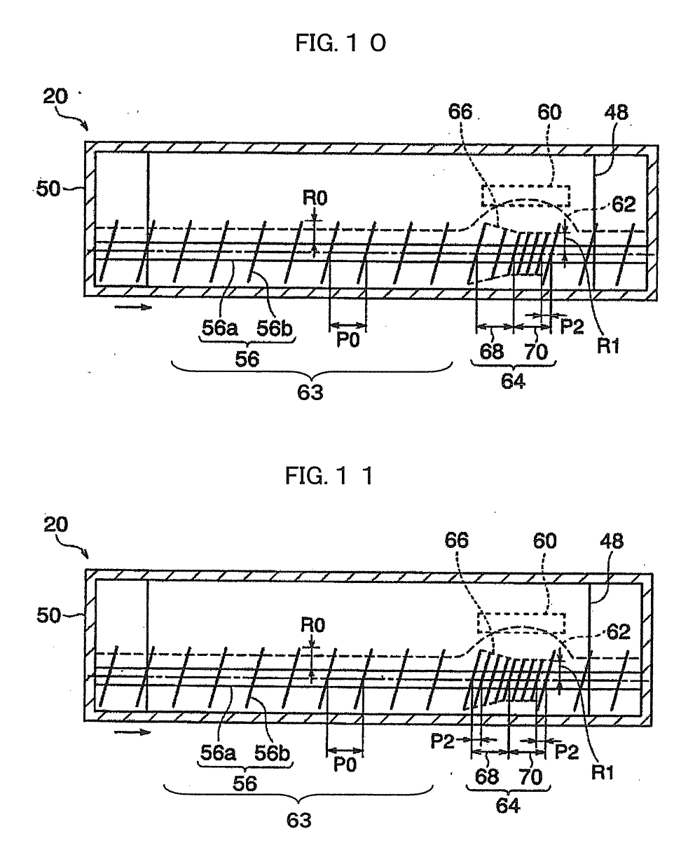

Next, a third example of the developing device according to this embodiment will be described. FIG. 10 is a sectional view of the third example of the developing device according to the fifth embodiment. Like FIG. 4A, FIG. 10 is a sectional view of the developing device, as viewed along the line Y2-Y2 in FIG. 2.

As shown in FIG. 10, in the third carrying part 68 in this example, the vane height and pitch of the rotary wing 56b are gradually decreasing from upstream to downstream in the developer carrying direction. In the fourth carrying part 70, the vane height and pitch of the rotary wing 56b are constant and equal to the vane height and pitch in the most downstream part of the third carrying part 68. With this configuration, the second quantity of carried developer is gradually reduced from the first quantity of carried developer and becomes constant in the fourth carrying part 70.

Here, the vane height of the rotary wing 56b in the most upstream part of the third carrying part 68 is R0, which is equal to the vane height of the rotary wing 56b in the first carrying part 63. If the vane height of the rotary wing 56b in the most downstream part of the third carrying part 68 (minimum value of the vane height of the rotary wing 56b in the third carrying part 68) is R1, for example, R1 is ½ of the vane height R0 of the rotary wing 56b in the first carrying part 63. The vane height of the rotary wing 56b in the fourth carrying part 70 is constantly R1, which is equal to the vane height of the rotary wing 56b in the most downstream part of the third carrying part 68. The pitch of the rotary wing 56b in the most upstream part of the third carrying part 68 is P0, which is equal to the pitch of the rotary wing 56b in the first carrying part 63. If the pitch of the rotary wing 56b in the most downstream part of the third carrying part 68 (minimum value of the pitch of the rotary wing 56b in the third carrying part 68) is P2, for example, P2 is ¼ of the pitch P0 of the rotary wing 56b in the first carrying part 63. The pitch of the rotary wing 56b in the fourth carrying part 70 is constant, and this pitch is P2.

Next, a fourth example of the developing device according to this embodiment will be described. FIG. 11 is a sectional view of the fourth example of the developing device according to the fifth embodiment. Like FIG. 4A, FIG. 11 is a sectional view of the developing device, as viewed along the line Y2-Y2 in FIG. 2.

As shown in FIG. 11, in the third carrying part 68 in this example, the vane height of the rotary wing 56b is gradually decreasing from upstream to downstream in the developer carrying direction. In the fourth carrying part 70, the vane height of the rotary wing 56b is constant and equal to the vane height in the most downstream part of the third carrying part 68. The pitch of the rotary wing 56b is constant in the third carrying part 68 and the fourth carrying part 70. With this configuration, the second quantity of carried developer is gradually reduced from the first quantity of carried developer and becomes constant in the fourth carrying part 70.

Here, the vane height of the rotary wing 56b in the most upstream part of the third carrying part 68 is R0, which is equal to the vane height of the rotary wing 56b in the first carrying part 63. If the vane height of the rotary wing 56b in the most downstream part of the third carrying part 68 (minimum value of the vane height of the rotary wing 56b in the second carrying part 64) is R1, for example, R1 is ½ of the vane height R0 of the rotary wing 56b in the first carrying part 63. The pitch of the rotary wing 56b is constant in the third carrying part 68 and the fourth carrying part 70. If this pitch is expressed as P2, for example, P2 is ¼ of the pitch P0 of the rotary wing 56b in the first carrying part 63.

According to this embodiment, since the second carrying part 64 has the third carrying part 63, where the quantity of carried developer is gradually decreasing from upstream to downstream in the developer carrying direction, and the fourth carrying part 70, which is formed downstream of the third carrying part 68 and where the developer is carried in the minimum quantity of carried developer in the third carrying part 68, abrupt rise of the developer surface 62 does not occur. Therefore, the advantages similar to those of the first embodiment can be achieved.

### Sixth Embodiment

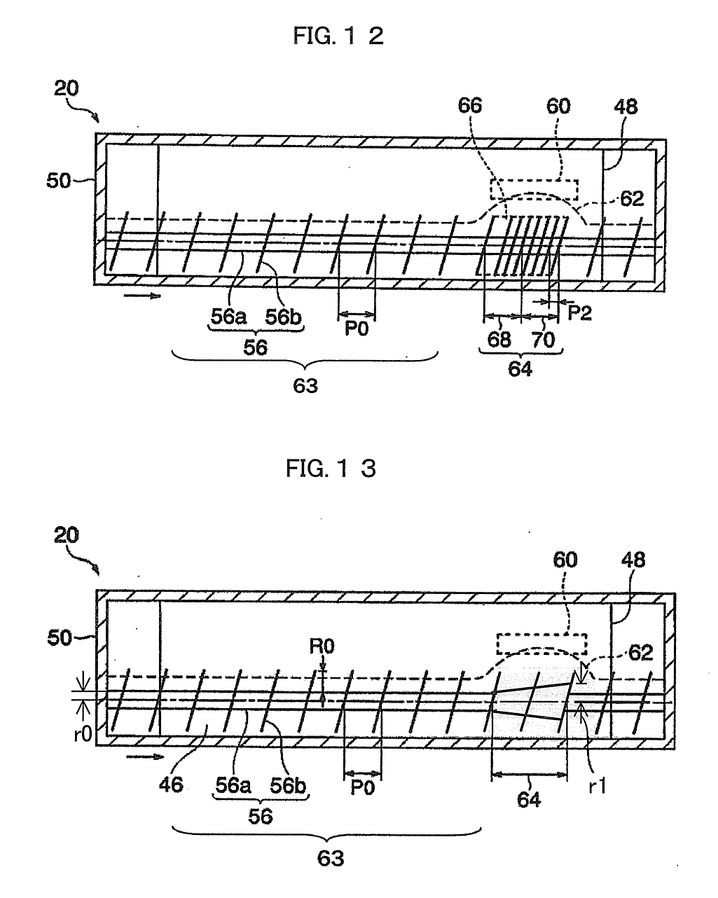

The schematic configurations of the image forming apparatus 1 and the developing device 20 according to this embodiment are similar to FIG. 1 and FIG. 2, respectively. Hereinafter, the same parts as in the first embodiment are denoted by the same reference numerals and only different parts from the first embodiment will be described. FIG. 12 is a sectional view of the developing device according to the sixth embodiment. Like FIG. 4A, FIG. 12 is a sectional view of the developing device, as viewed along the line Y2-Y2 in FIG. 2.

The second carrying part 64 in this embodiment has a third carrying part 68 where the quantity of carried developer is gradually shifted to a smaller quantity, and a fourth carrying part 70 which is formed to continue from the downstream side of the third carrying part 68 and which holds a constant quantity of carried developer.

As shown in FIG. 12, in the third carrying part 68 in this embodiment, the pitch of the rotary wing 56b is gradually decreasing from upstream to downstream in the developer carrying direction. In the fourth carrying part 70, the pitch of the rotary wing 56b is constant and equal to the pitch in the most downstream part of the third carrying part 68. Meanwhile, the vane height of the rotary wing 56b is constant in the third carrying part 68 and the fourth carrying part 70. With this configuration, the second quantity of carried developer is gradually reduced from the first quantity of carried developer in the third carrying part 68 and becomes constant in the fourth carrying part 70.

Here, the pitch of the rotary wing 56b in the most upstream part of the third carrying part 68 is P0, which is equal to the pitch of the rotary wing 56b in the first carrying part 63. If the pitch of the rotary wing 56b in the most downstream part of the third carrying part 68 (minimum value of the pitch of the rotary wing 56b in the third carrying part 68) is P2, for example, P2 is ¼ of the pitch P0 of the rotary wing 56b in the first carrying part 63. The pitch of the rotary wing 56b in the fourth carrying part 70 is constantly P2. The vane height of the rotary wing 56b in the third carrying part 68 and the fourth carrying part 70 is R0, which is equal to the vane height of the rotary wing 56b in the first carrying part 63.

According to this embodiment, since the second carrying part 64 has the third carrying part 63, where the quantity of carried developer is gradually decreasing from upstream to downstream in the developer carrying direction, and the fourth carrying part 70, which is formed downstream of the third carrying part 68 and where the developer is carried in the minimum quantity of carried developer in the third carrying part 68, abrupt rise of the developer surface 62 does not occur. Therefore, the advantages similar to those of the first embodiment can be achieved.

### Seventh Embodiment

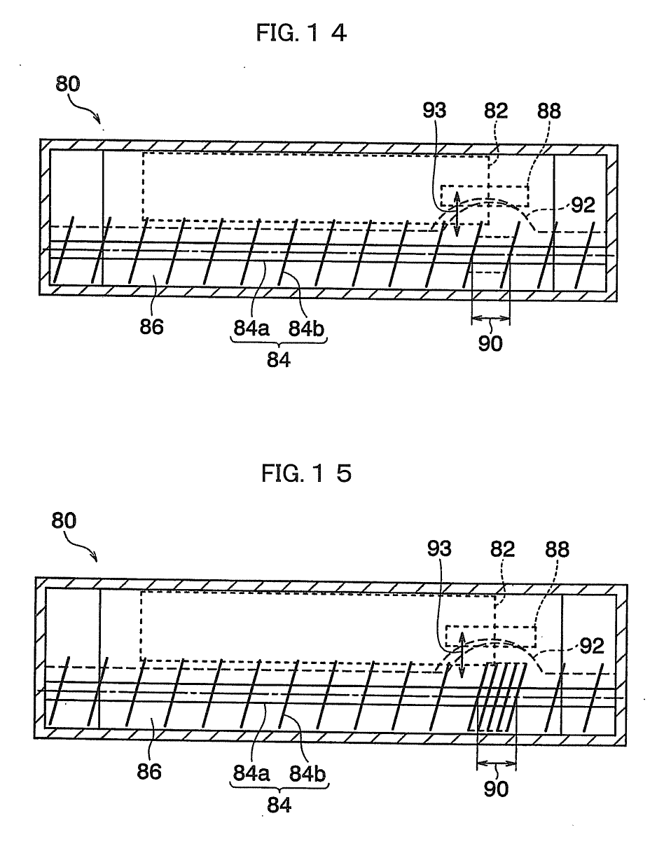

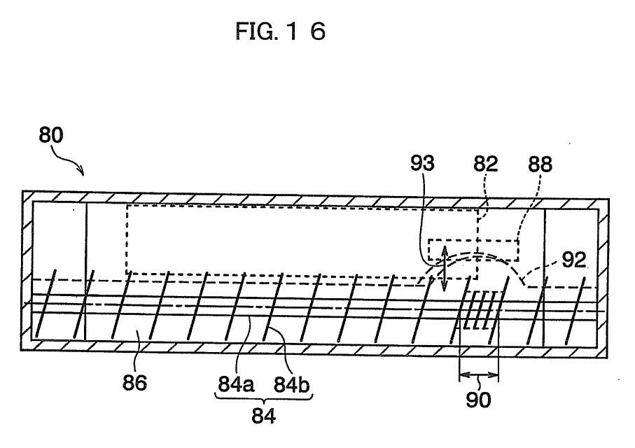

The schematic configurations of the image forming apparatus 1 and the developing device 20 according to this embodiment are similar to FIG. 1 and FIG. 2, respectively. Hereinafter, the same parts as in the first embodiment are denoted by the same reference numerals and only different parts from the first embodiment will be described. FIG. 13 is a sectional view of developing device according to the seventh embodiment. Like FIG. 4A, FIG. 13 is a sectional view of the developing device, as viewed along the line Y2-Y2 in FIG. 2.

As shown in FIG. 13, in the second carrying part 64 in this embodiment, the shaft diameter of the rotary shaft 56a is gradually increasing from upstream to downstream in the developer carrying direction. With this configuration, the second quantity of carried developer is gradually reduced from the first quantity of carried developer. Here, if the shaft diameter of the rotary shaft 56a in the first carrying part 63 is r0 and the shaft diameter of the rotary shaft 56a in the downstream part of the second carrying part 64 (maximum value of the shaft diameter of the rotary shaft 56a in the second carrying part 64) is r1, for example, r1 is twice the shaft diameter r0 of the rotary shaft 56a in the first carrying part 63. As shown in FIG. 13, the pitch of the rotary wing 56b in the second carrying part 64 is constantly P0, which is equal to the pitch of the rotary wing 56b in the first carrying part 63. The outer diameter of the rotary wing 56b in the second carrying part 64 is constant and equal to the outer diameter of the rotary wing 56b in the first carrying part 63. Therefore, the vane height of the rotary wing 56b in the second carrying part 64 is gradually decreasing from upstream to downstream in the developer carrying direction.

According to this embodiment, since the second carrying part 64 is provided in which the shaft diameter of the rotary shaft 56a is gradually increasing from upstream to downstream in the developer carrying direction, the quantity of carried developer is gradually decreasing from upstream to downstream in the developer carrying direction in the second carrying part 64 and abrupt rise of the developer surface 62 does not occur. Therefore, the advantages similar to those of the first embodiment can be achieved.

The position or size of the rise of the developer surface 62 raised by the second carrying part 64 according to the above embodiments varies depending on the shape of the second carrying part 64. Therefore, it is not limited to the relations between size and arrangement shown in the drawings used for the description of the above embodiments. That is, it suffices that the excess developer is stably discharged from the developer discharge port 60 when the rise of the developer surface 62 has reached a predetermined height or more. With respect to the size of the developer discharge port 60 and the second carrying part 64 in the developing device according to the invention, the developer discharge port 60 may have a width broader or narrower than the second carrying part 64. Also, the position where the developer discharge port 60 is arranged may be slightly shifted forward or backward from the second carrying part 64.

In addition, the invention is not limited to the configuration in which the second carrying part 64 is provided in the second developer carrying member 56, as in the above embodiments. In the case where the developer discharge port 60 is provided in the first developer carrying path 44, as a matter of course, the second carrying part 64 is provided in the first developer carrying member 54. Moreover, various changes may be made in the dimension and shape of the second carrying part 64 without departing from the scope of the invention, and the above embodiments may be suitably combined.

As described above in detail, according to the invention, a developing device that enables stable discharge of a developer from a developer discharge port, and an image forming apparatus having this developing device can be provided.

What is claimed is:

1. A developing device in which a developer is supplied to a developing roller and the developer is carried while it is stirred, comprising:
a developer passage through which the developer can be carried;
a carrying member which is provided in the developer passage and has a rotary shaft and a rotary wing spirally provided along an outer circumference of the rotary shaft, in which the rotary wing rotates about the rotary shaft, thereby carrying the developer into a carrying direction along the rotary shaft, and which has a first section where the rotary wing has a constant characteristic in the carrying direction and a second section where the characteristic of the rotary wing gradually changes with respect to position in the carrying direction; and
a discharge port provided at a position in the carrying direction that is in a section overlapping the second section or a section downstream of the second section in the carrying direction, and adapted for discharging the developer having a surface height of a predetermined value or more, from the developer passage.

2. The developing device according to claim 1, wherein the characteristic includes at least one of vane height of the rotary wing, pitch of the rotary wing, and shaft diameter of the rotary shaft.

3. The developing device according to claim 1, wherein the section includes plural sections, and in each of the plural sections, the characteristic of the rotary wing is constant and is different from the characteristic of the rotary wing in an upstream section next to the section in the carrying direction.

4. The developing device according to claim 1, wherein the carrying member further includes a third section which is provided next to and downstream of the second section in the carrying direction and which has a rotary wing having the same characteristic as the characteristic of the rotary wing in a most downstream part in the carrying direction of the second section.

5. The developing device according to claim 4, including at least one of a configuration in which the vane height of the rotary wing gradually decreases with respect to position in the carrying direction, a configuration in which the pitch of the rotary wing gradually decreases with respect to position in the carrying direction, and a configuration in which the shaft diameter of the rotary shaft gradually increases with respect to position in the carrying direction.

6. The developing device according to claim 5, wherein the second section has a configuration in which the vane height and the pitch of the rotary wing gradually decrease with respect to position in the carrying direction.

7. A developing device in which a developer is supplied to a developing roller and the developer is carried while it is stirred, comprising:
a developer passage through which the developer can be carried;
carrying means provided in the developer passage and having a first section where the developer is carried in a predetermined quantity of carried developer into a developer carrying direction and a second section where the quantity of the carried developer is equal to or less than the quantity of carried developer in the first section and the quantity of the carried developer is gradually reduced with respect to position in the carrying direction; and
discharge means for discharging the developer having its surface raised in the second section, from the developer passage.

8. The developing device according to claim 7, wherein the discharge means is provided at a position in the carrying direction that is in a section overlapping the second section or a section downstream of the second section in the carrying direction.

9. The developing device according to claim 7, wherein the second section of the carrying means includes plural sections in the carrying direction, and in each of the plural sections, the developer is carried in a constant quantity of carried developer smaller than the quantity of carried developer in an upstream section next to the section in the carrying direction.

10. The developing device according to claim 7, the carrying means further includes a third section which is provided next to and downstream of the second section in the carrying direction and in which the developer is carried in a minimum quantity of carried developer of the second section.

11. The developing device according to claim 7, wherein the carrying means has a rotary shaft along the carrying direction and a rotary wing spirally provided along an outer circumference of the rotary shaft, and the rotary wing rotates about the rotary shaft, thereby carrying the developer in the carrying direction.

12. The developing device according to claim 11, wherein in the second section of the carrying means, at least one of vane height of the rotary wing, pitch of the rotary wing and shaft diameter of the rotary shaft gradually changes with respect to position in the developer carrying direction.

13. The developing device according to claim 12, the second section of the carrying means includes at least one of a configuration in which the vane height of the rotary wing gradually decreases with respect to position in the developer carrying direction, a configuration in which the pitch of the rotary wing gradually decreases with respect to position in the developer carrying direction, and a configuration in which the shaft diameter of the rotary shaft gradually increases with respect to position in the developer carrying direction.

14. The developing device according to claim 13, the second section of the carrying means has a configuration in which the vane height and the pitch of the rotary wing gradually decrease with respect to position in the developer carrying direction.

15. An image forming apparatus in which a developer is carried while it is stirred, comprising:
a developer passage through which the developer can be carried;
a carrying member which is provided in the developer passage and has a rotary shaft and a rotary wing spirally provided along an outer circumference of the rotary shaft, in which the rotary wing rotates about the rotary shaft, thereby carrying the developer into a carrying direction along the rotary shaft, and which has a first section where the rotary wing has a constant characteristic in the carrying direction and a second section where the characteristic of the rotary wing gradually changes with respect to position in the carrying direction;
a discharge port provided at a position in the carrying direction that is in a section overlapping the second section or a section downstream of the second section in the carrying direction, and adapted for discharging the developer having a surface height of a predetermined value or more, from the developer passage; and
a developing roller which develops an electrostatic latent image by using the developer carried by the carrying member.
